(19) United States
(12) Patent Application Publication
(10) Pub. No.: US 2022/0268628 A1
(43) Pub. Date: Aug. 25, 2022

(54) DEVICES, SYSTEMS, AND METHODS FOR SPECTROSCOPY HAVING AN ADJUSTABLE PATHLENGTH

(71) Applicant: Repligen Corporation, Waltham, MA (US)

(72) Inventors: Rene Daniel Jean-Marie Gantier, Arlington, MA (US); Mark C. Salerno, Cranford, NJ (US)

(73) Assignee: Repligen Corporation, Waltham, MA (US)

(21) Appl. No.: 17/672,959

(22) Filed: Feb. 16, 2022

Related U.S. Application Data
(60) Provisional application No. 63/152,992, filed on Feb. 24, 2021.

(51) Int. Cl. G01J 3/42; G01N 21/31

(52) U.S. Cl. CPC G01J 3/42; G01N 21/3103; G01N 21/05

(57) ABSTRACT

The present disclosure relates to spectroscopy with light emitting components including, e.g., UV and/or visible wavelength light, for various applications, including, e.g., chromatography, and more particularly, for a sampling device that facilitates spectroscopic measurements with a variable pathlength and methods for such a device. In an aspect, a device for measuring light absorbance of a sample may include a fluid conduit comprising a first portion, a midportion substantially perpendicular to the first portion, and a second portion substantially perpendicular to the midportion. A first probe may be within the midportion and substantially parallel with the midportion. The first probe may comprise a distal end. A light source may be operably coupled to the first probe. A detector may be aligned with the distal end of the first probe substantially perpendicular to the first probe at a pathlength from the distal end of the first probe.

### CROSS-REFERENCE TO RELATED APPLICATIONS

This is a nonprovisional of pending U.S. provisional patent application Ser. No. 63/152,992, filed Feb. 24, 2021, the entirety of which application is incorporated by reference herein.

### FIELD

The present disclosure relates to spectroscopy with light emitting components including, e.g., UV and/or visible wavelength light, for various applications, including, e.g., chromatography, and more particularly, for a sampling device that facilitates spectroscopic measurements with a variable pathlength and methods for such a device.

### BACKGROUND

Spectroscopic analysis may determine the composition and properties of a material from the spectra arising from interaction (e.g., absorption, luminescence, or emission) of the material with energy. Absorption spectroscopy measures the optical absorption spectra of a sample fluid. Often the compound of interest in a sample (e.g., a solution, or the like) is highly concentrated. For example, certain biological samples, such as proteins, DNA, RNA, or the like are often isolated in concentrations that fall outside the linear range of a spectrophotometer when absorbance is measured. Therefore, dilution of the sample is often required to measure an absorbance value that falls within the linear range of the instrument. Samples may be dilute for alternative reasons such as scarcity or cost per volume. Such dilute samples may be harder for spectroscopy to measure absorbance compared to more concentrated samples. It is with respect to these considerations that the devices, systems, and methods of the present disclosure may be useful.

### SUMMARY

Spectroscopy processing systems analyzing a sample may be arranged with a detector measuring light absorbance across a pathlength and may be installed in fluid communication with or without upstream and/or downstream processes. In an aspect of an embodiment described herein, a device for measuring light absorbance of a sample may include a fluid conduit comprising a first portion, a midportion substantially perpendicular to the first portion, and a second portion substantially perpendicular to the midportion. A first probe may be within the midportion and substantially parallel with the midportion. The first probe may comprise a distal end. A light source may be operably coupled to the first probe. A detector may be aligned with the distal end of the first probe substantially perpendicular to the first probe at a pathlength from the distal end of the first probe.

In various embodiments, the midportion may comprise a length that is adjustable such that the pathlength is adjusted. The length of the midportion that is adjustable may comprise a conduit wall that is axially foldable. A helical coil may be within the wall along the length of the midportion. The length of the midportion that is adjustable may comprise a plurality of telescoping walls. A scaffolding may extend between the first portion and the second portion along the mid portion. The scaffolding may comprise a reversibly locking telescoping portion. The scaffolding may comprise a screw and threads. The first probe may be substantially fixed to the fluid conduit. A lens may be coincident with the pathlength. A second probe may be between the first probe and the detector.

In an aspect of an embodiment described herein, a device for measuring light absorbance of a sample may include a fluid conduit comprising a first portion, a midportion substantially perpendicular to the first portion, and a second portion substantially perpendicular to the midportion. A first probe may be extendable within the midportion. A light source may be coupled to the first probe. A detector may be arranged substantially perpendicular to the light source emitting from the first probe at a pathlength from the distal end of the first probe.

In various embodiments, a lens may be coincident with the pathlength. A second probe may be between the first probe and the detector.

In an aspect of an embodiment described herein, a device for measuring light absorbance of a sample may include a fluid conduit comprising a first portion, a midportion substantially perpendicular to the first portion, and a second portion substantially perpendicular to the midportion. A restrictor valve may be coupled to the second portion. A probe may be extendable within the midportion. A light source may be coupled to the first probe. A detector may be arranged substantially perpendicular to the light source emitting from the first probe at a pathlength from the distal end of the first probe. The first portion and the second portion may be substantially aligned along a parallel axis, and the midportion comprises a reservoir extending away from the parallel axis. The restrictor valve may be configured to reduce a flowrate of the sample from the mid portion through the second portion such that a head is established along the probe. The pathlength and the head may be related to each other. The first portion may be downstream of a chromatography column. The probe may be substantially parallel with the midportion.

### BRIEF DESCRIPTION OF THE DRAWINGS

The above and other aspects of the present disclosure will be more apparent from the following detailed description, presented in conjunction with the following drawings wherein:

FIG. 1A illustrates a device for measuring light absorbance with a concentrated sample, in accordance with an embodiment of the present disclosure.

FIG. 1B illustrates the device of FIG. 1A with a diluted sample.

FIG. 2A illustrates a device for measuring light absorbance with a concentrated sample, in accordance with an embodiment of the present disclosure.

FIG. 2B illustrates the device of FIG. 2A with the sample advancing through a conduit.

FIG. 2C illustrates a time graph measuring absorbance of the sample of FIG. 2B.

FIG. 2D illustrates the device of FIGS. 2A and 2B with the sample advancing through the conduit.

FIG. 2E illustrates a time graph measuring absorbance of the sample of FIG. 2D.

FIG. 3A illustrates a device for measuring light absorbance with a diluted sample, in accordance with an embodiment of the present disclosure.

FIG. 3B illustrates the device of FIG. 3A with the sample advancing through a conduit.

FIG. 3C illustrates a time graph measuring absorbance of the sample of FIG. 3B.

FIG. 3D illustrates the device of FIGS. 3A and 3B with the sample advancing through the conduit.

FIG. 3E illustrates a time graph measuring absorbance of the sample of FIG. 3D.

FIG. 4A illustrates a device for measuring light absorbance with a diluted sample, in accordance with an embodiment of the present disclosure.

FIG. 4B illustrates the device of FIG. 4A with a pathlength shortened

FIG. 4C illustrates the device of FIG. 4A with the diluted sample advancing through a conduit.

FIG. 4D illustrates a time graph measuring absorbance of the sample of FIG. 4C.

FIG. 4E illustrates the device of FIGS. 4A and 4C with the sample advancing through the conduit.

FIG. 4F illustrates a time graph measuring absorbance of the sample of FIG. 4E.

FIG. 4G illustrates the device of FIGS. 4A, 4C, and 4E with the sample advancing through the conduit.

FIG. 4H illustrates a time graph measuring absorbance of the sample of FIG. 4G.

FIG. 5 illustrates a device for measuring light absorbance including lenses, in accordance with an embodiment of the present disclosure.

FIG. 6 illustrates a device for measuring light absorbance with a diluted sample, in accordance with an embodiment of the present disclosure.

FIG. 7 illustrates a device for measuring light absorbance, in accordance with an embodiment of the present disclosure.

### DETAILED DESCRIPTION

### Overview

Separated samples (i.e., from chromatography) of lower concentration (e.g., compared to higher concentration samples, that may be comparatively dilute or diluted) may be difficult to measure by spectroscopy devices. For example, a dilute sample may require a large pathlength between a light emitting probe (e.g., a polished optical fiber, a fibrette, or the like) and a detector in order for separate molecules of the dilute sample to absorb the light emitted. The embodiments described herein include a variable pathlength spectrophotometer that may adapt to sample parameters (e.g., dilution, concentration, volume, or the like) to expand the dynamic range of spectroscopy such that samples of various concentrations can be measured without further dilution or further concentration of the sample or excess post-processing of data. These and other advantages of the disclosure are apparent from the description provided herein.

### Example Embodiments

The absorption spectrum is the distribution of light attenuation (due to absorbance) as a function of light wavelength. For example, with use of a spectrophotometer, a sample substance to be studied may be positioned between a light source (e.g., emitted from a probe) and a detector. Electromagnetic radiation (e.g., light) of a known wavelength, λ, (e.g., ultraviolet, infrared, visible, etc.) and intensity I may be emitted from the probe. The detector opposite the probe and the sample may measure the intensity I of light received. The length that the light propagates through the sample is a pathlength 1. For a sample consisting of a single homogeneous substance (or a separate substance) with a concentration c, the light transmitted through the sample will follow a relationship know as Beer's Law: A=εc1 where λ is the absorbance (also known as the optical density (OD) of the sample at wavelength λ where OD=the −log of the ratio of transmitted light to the incident light), ε is the absorptivity or extinction coefficient (normally at constant at a given wavelength), c is the concentration of the sample, and 1 is the pathlength of light through the sample.

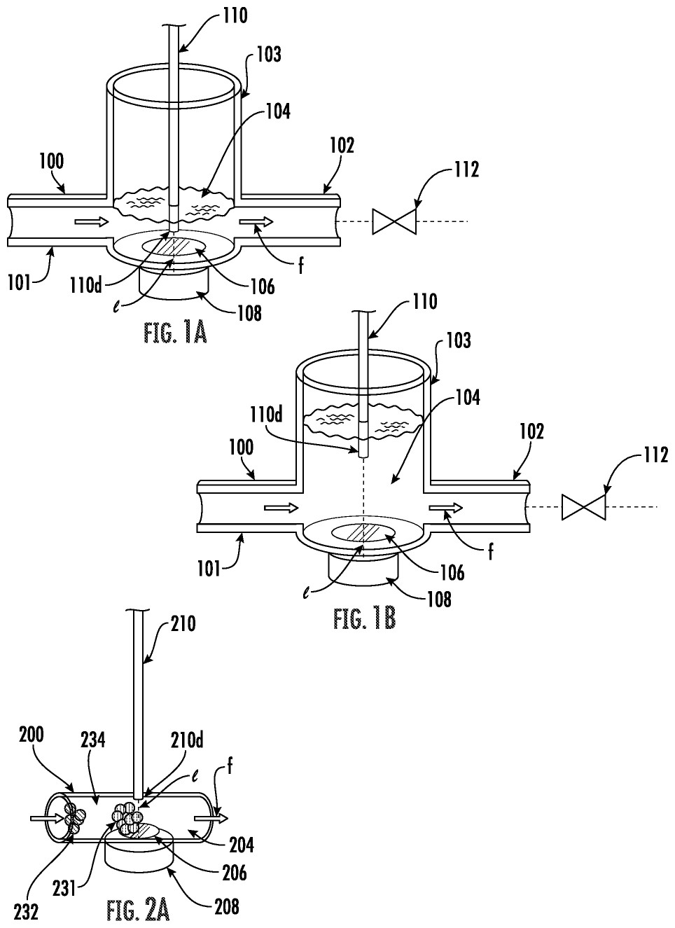

Referring to FIGS. 1A and 1B, a device for measuring light absorbance of a sample 104 according to an exemplary embodiment of the present disclosure is illustrated, which includes a fluid conduit 100. The fluid conduit 100 includes a first portion 101, a midportion 103 substantially perpendicular to the first portion 101, and a second portion 102 substantially perpendicular to the midportion 103. The fluid sample 104 is flowing in the direction of the arrows f from the first portion 101, through the midportion 103, and through the second portion 102. A probe 110 is extending within the midportion 103 substantially parallel with the midportion 103. A light source is operably coupled to the probe 110 (e.g., at or along a proximal end of the probe 110) such that light travels along the probe 110 and is emitted from a distal end 110d of the probe 110, submerged in the sample 104. A detector 108 is aligned with the distal end 110d of the probe 110 such that a receptive surface of the detector 108 is substantially perpendicular to the probe 110. Light emitted from the probe 110 travels across a window 106 of the midportion 103 to the detector 108. A distance that the light travels from the distal end 110d of the probe 110 to the detector 108 is a pathlength [symbol] that may be adjusted as desired and as described herein throughout the embodiments. The pathlength [symbol] may be adjusted (e.g., to create a larger pathlength [symbol] for a diluted sample 104 of FIG. 1B compared to the concentrated sample 104 of FIG. 1A) by adjusting the position of the distal end 110d. The pathlength [symbol] in FIG. 1B is larger than the pathlength [symbol] in FIG. 1A. The sample 104 in the midportion 103 of FIG. 1B has more head than that of FIG. 1A such that the distal end 110d of the probe 110 is submerged in the sample 104 with the greater pathlength [symbol] . The larger head of the sample 104 in the midportion 103 of FIG. 1B than that of FIG. 1A may be accomplished, e.g., by restricting flow of the sample 104 from the second portion 102 with a valve 112 (e.g., a ball valve, a pinch valve, or the like).

As used herein, “adjusting the probe”, “moving the probe”, or “adjusting the pathlength” may be relative to a conduit, window, sample, lens, probe, and/or detector and means that one or more of these components are adjusted or moved relative to each other. For example, this encompasses situations where the probe is moved and the conduit or sample is stationary, the conduit or sample is moved and the probe is stationary, and where the sample or the conduit is moved and the probe is also moved.

As used herein, “sample(s)” may include, but is not limited to, compounds, mixtures, solutions, emulsions, suspensions, cell cultures, fermentation cultures, cells, tissues, secretions, fluids, and extracts.

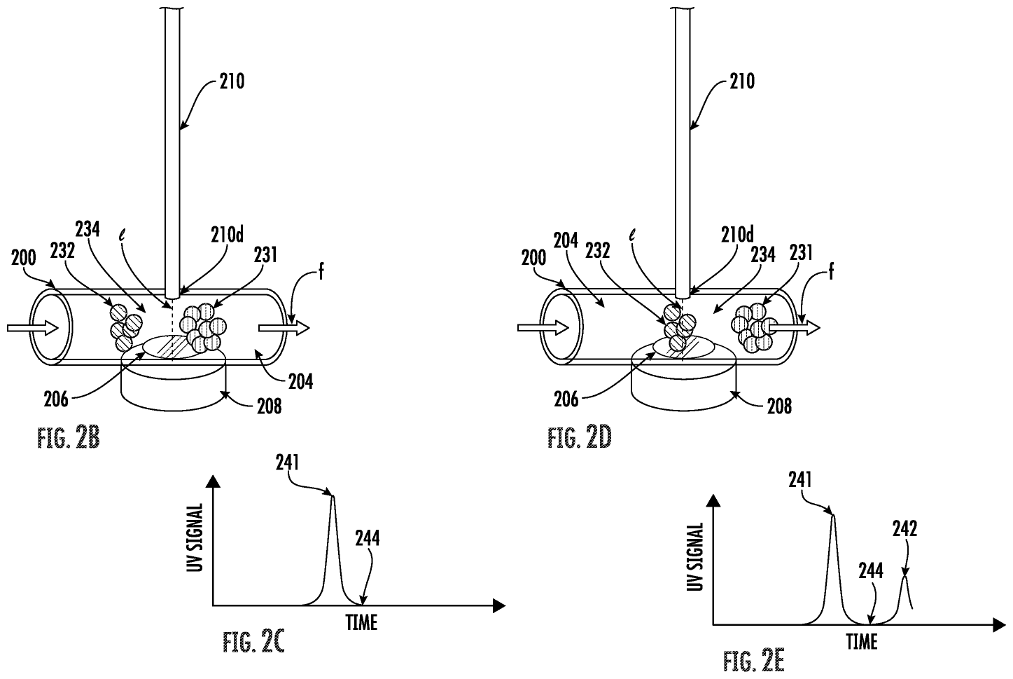

Referring to FIGS. 2A through 2E, a device for measuring light absorbance of a concentrated sample 204 according to an exemplary embodiment of the present disclosure is illustrated, which includes a fluid conduit 200. The fluid sample 204 is flowing in the direction of the arrows f through the conduit 200. The sample 204 includes a first component 231 that is separated downstream from a second component 232, e.g., as processed by a column upstream from the conduit 200. A probe 210 is extending within the conduit 200 substantially perpendicular with the conduit 200. A light source is operably coupled to the probe 210 (e.g., at or along a proximal end of the probe 210) such that light travels along the probe 210 and is emitted from a distal end 210d of the probe 210, submerged in the sample 204. A detector 208 is aligned with the distal end 210d of the probe 210 such that the detector 208 is substantially perpendicular to the probe 210. Light emitted from the probe 210 travels across a window 206 of the conduit 200 to the detector 208. A distance that the light travels from the distal end 210d of the probe 210 to the detector 208 is a pathlength [symbol] . The detector 208 can measure an absorbance reading of the sample 204 flowing through the conduit 200 over time. As the components 231, 232 of the sample 204 flow across the pathlength [symbol] , the detector 208 can measure an absorbance of the light emitted from the probe 210 by each component 231, 232. As illustrated in FIGS. 2C and 2E, a first peak 241 is a measured absorbance of light of the first component 231 flowing across the pathlength [symbol] . In FIG. 2B, the sample 204 continues to flow through the conduit 200 from the instant illustrated in FIG. 2A. Because there is a gap space 234 in the sample 204 between the first component 231 and the second component 232, the space 234 may flow across the pathlength [symbol] with substantially no first and second components 231, 232 present at the pathlength [symbol] . A valley 244 in FIG. 2C occurs after the first peak 241 where substantially no light is absorbed by the space 234 at the pathlength [symbol] . In FIG. 2D, the sample 204 continues to flow through the conduit 200 from the instant illustrated in FIG. 2B. As illustrated in FIGS. 2D and 2E, the second component 232 flows across the pathlength [symbol] and the detector 208 is able to measure an absorbance of light that forms a second peak 242. Because of the space 234 in the sample 204 between the first component 231 and the second component 232, there is a valley 244 of substantially no measured light absorption between the first peak 241 and the second peak 242. The valley 244 separates the first and second peaks 241, 242 such that the peaks 241, 242 are substantially clear and identifiable for analysis.

As used herein, an “absorbance reading” means any absorbance reading(s) measured by a device or instrument. This includes absorbance readings taken at a single wavelength and/or a single pathlength or where the reading is taken at multiple wavelengths (such as in a scan) and/or multiple pathlengths, including section data (e.g., absorbance in relation to pathlength, slope spectroscopy, Beer's Law, or the like). In various embodiments, multiple absorbance measurements may be taken at multiple path lengths without accurately knowing what a path length distance is. In various embodiments, multiple absorbance measurements made at different path lengths enables an accurate calculation of the concentration based upon a device's ability to calculate a regression line from the absorbance and path length information. A slope of the regression line can be used to calculate the concentration of the sample. Each path length need not be accurately known because software may be used to calculate the regression line and can be programmed to select the most accurate line from the data set presented. The number of data points taken in these methods may “smooth out” any perturbations in the path length or absorbance reading such that regression lines with very high R² values can be obtained. In the methods of the present invention R² values of at least 0.99999 have been achieved. As an R² value increases, so may the accuracy of the slope that results for determining a concentration of the sample. Any R² value between 0 and 0.99999 may be achievable in the devices and methods herein. In various embodiments a R² value may exceed about 0.95000 or about 0.99500. In various embodiments, a R² value may be between about 0.95000 and about 0.99999, about 0.99500 and about 0.99999, and about 0.99990 and about 0.99999. While R² may measure goodness-of-fit for a linear regression, any mathematic expression that measures goodness-of-fit may be utilized in the embodiments herein.

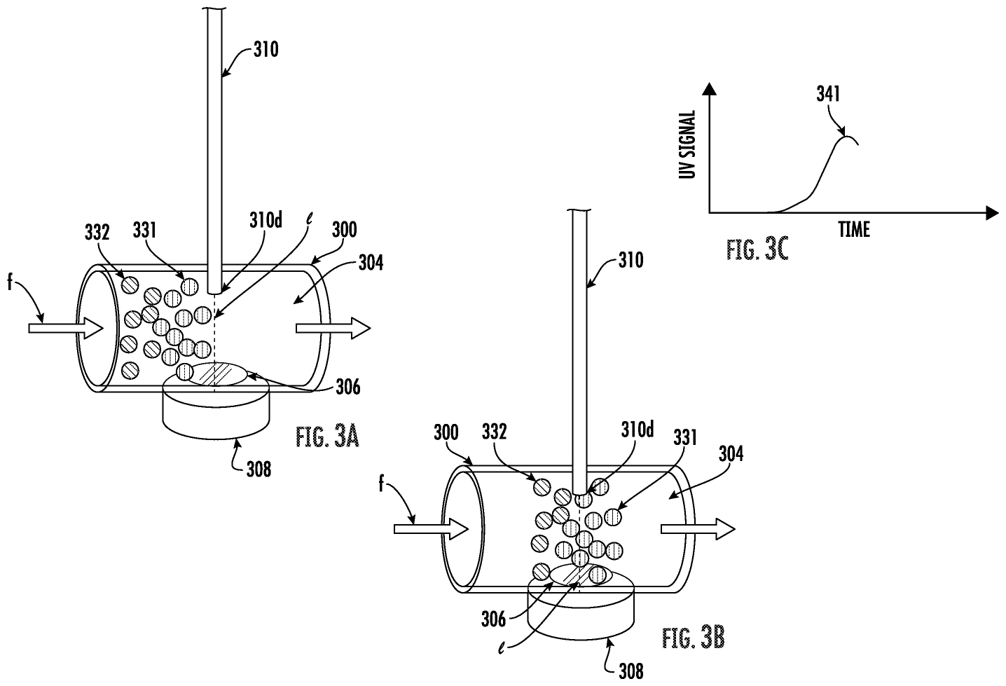

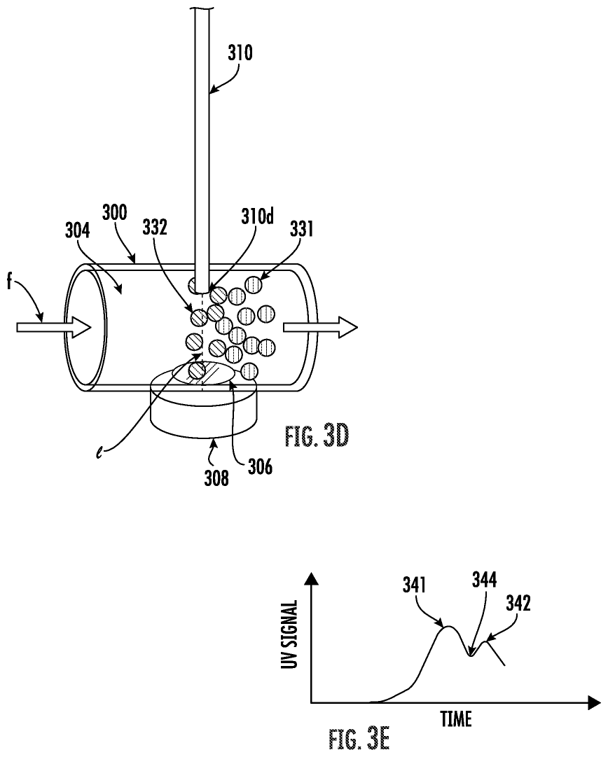

Referring to FIGS. 3A through 3E, a device for measuring light absorbance of a diluted sample 304 according to an exemplary embodiment of the present disclosure is illustrated, which includes a fluid conduit 300. A probe 310 extending within the conduit 300 is operably coupled with a light source such that light travels along the probe 310 and is emitted from a distal end 310d of the probe 310 submerged in the sample 304. A detector 308 is aligned with the distal end 310d of the probe 310 such that a receptive surface of the detector 308 is substantially perpendicular to the probe 310. Light emitted from the probe 310 travels across a window 306 of the conduit 300 to the detector 308. A distance that the light travels from the distal end 310d of the probe 310 to the detector 308 is a pathlength [symbol] . The detector 308 can measure an absorbance reading of the sample 304 flowing through the conduit 300 over time. The sample 304 includes a first component 331 that is at least partially downstream from a second component 332, e.g., as processed by a column upstream from the conduit 300. The sample 304 is flowing in the direction of the arrows f through the conduit 300 and is more dilute and/or has been diluted compared to that of the sample 200 of FIGS. 2A-2E. Because the sample 304 is dilute, a pathlength [symbol] is increased compared to that of FIGS. 2A-2E. Because the pathlength [symbol] is increased, a diameter of the conduit 300 is also increased. Because the diameter and cross-sectional area for the sample 304 to flow through is larger (i.e., compared to that of FIGS. 2A-2E), the first and second components 331, 332 of the sample 304 have not maintained spaced separation after column processing. In FIG. 3B, the sample 304 continues to flow through the conduit 300 from the instant illustrated in FIG. 3A. As the components 331, 332 of the sample 304 flow across the pathlength [symbol] , the detector 308 can measure an absorbance of the light emitted from the probe 310 by the sample 304. As illustrated in FIGS. 3C and 3E, the first peak 341 is a measured absorbance of light of the first component 331 flowing across the pathlength [symbol] . As illustrated in FIGS. 3D and 3E, as the second component 332 flows across the pathlength [symbol] , the detector 308 is able to measure an absorbance of light that forms a second peak 342. Because there is no significant gap space in the sample 304 between the first component 331 and the second component 332, a valley 344 in FIG. 3E that separates the first and second peaks 341, 342 renders the peaks 341, 342 not as substantially clear and identifiable for analysis as the peaks 241, 242 of FIG. 2E are.

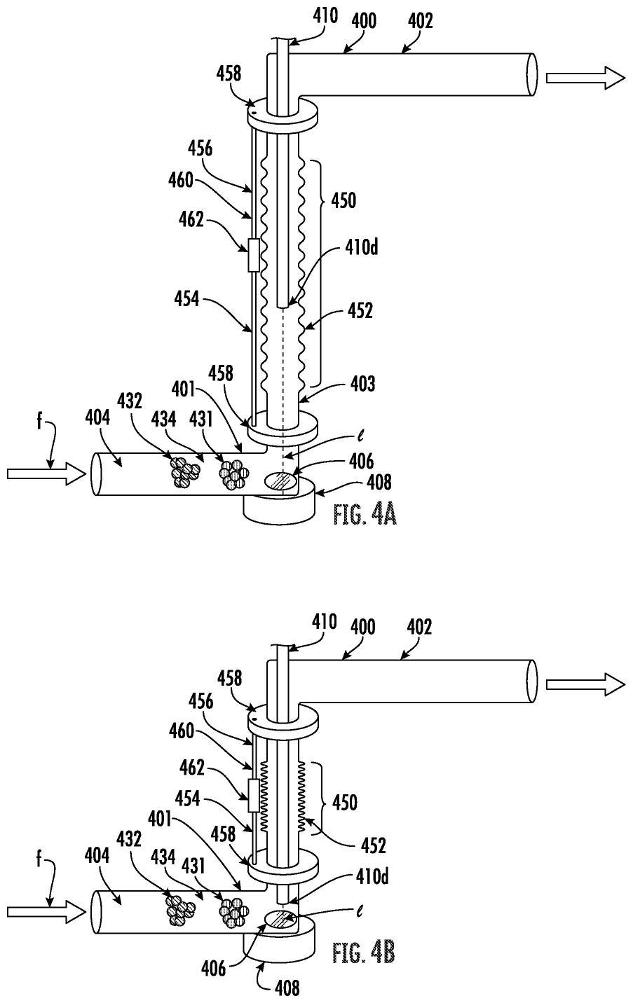

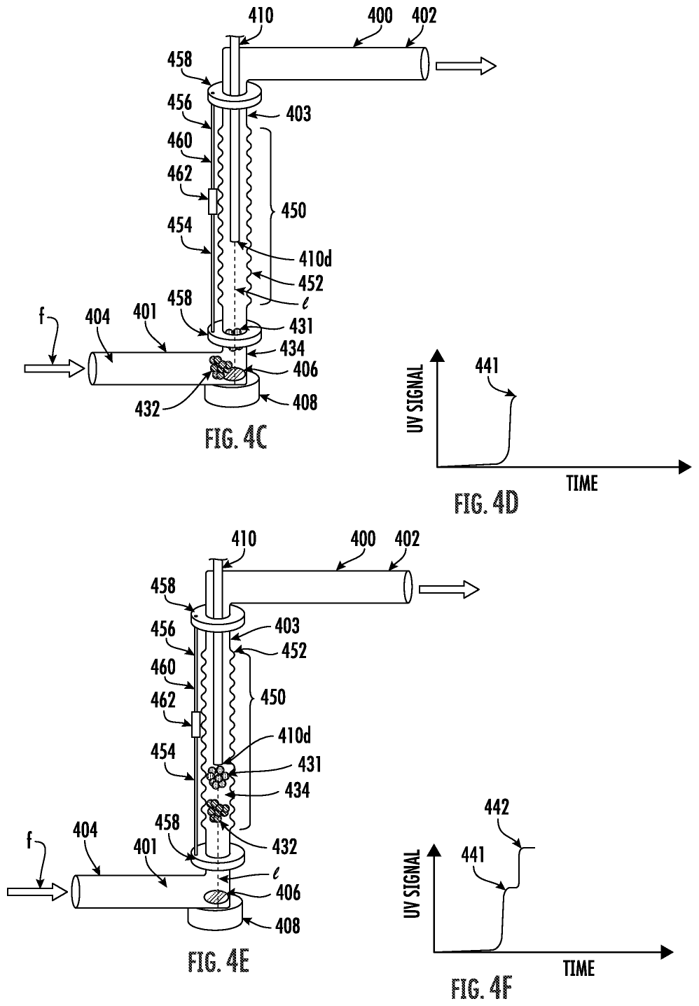

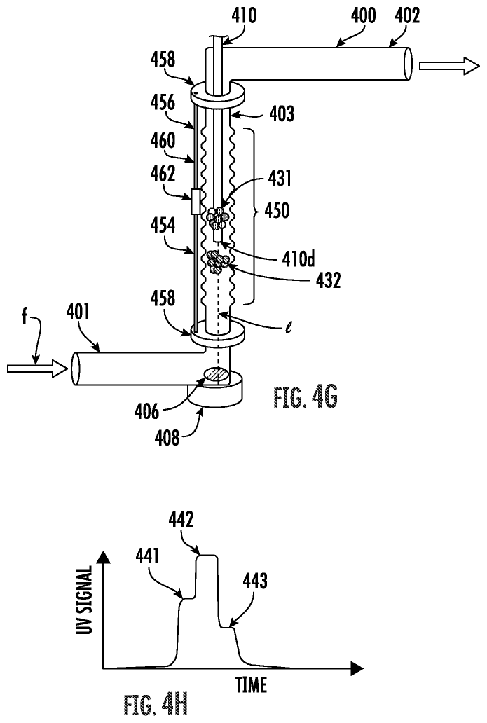

Referring to FIGS. 4A-4C, 4E, and 4G a device for measuring light absorbance of a sample 404 according to an exemplary embodiment of the present disclosure is illustrated, which includes a fluid conduit 400. The fluid conduit 400 includes a first portion 401, a midportion 403 substantially perpendicular to the first portion 401, and a second portion 402 substantially perpendicular to the midportion 403. The fluid sample 404 is flowing in the direction of the arrows f from the first portion 401, through the midportion 403, and through the second portion 402. A probe 410 is extending within the midportion 403 substantially parallel with the midportion 403. A light source is operably coupled to the probe 410 (e.g., at or along a proximal end of the probe 410) such that light travels along the probe 410 and is emitted from a distal end 410d of the probe 410 submerged in the sample 404. A detector 408 is aligned with the distal end 410d of the probe 410 such that a receptive surface of the detector 408 is substantially perpendicular to the probe 410. Light emitted from the probe 410 travels across a window 406 of the midportion 403 to the detector 408. A distance that the light travels from the distal end 410d of the probe 410 to the detector 408 is a pathlength [symbol] that may be adjusted as desired and as described herein throughout the embodiments. The mid portion 403 The pathlength [symbol] may be adjusted (e.g., to create a larger pathlength [symbol] for a diluted sample compared to a concentrated sample) by adjusting the position of the distal end 410d with respect to the detector 408. The midportion 403 includes a length 450 having an adjustable conduit wall that is axially foldable. The conduit wall of the length 450 includes ridges 452 that can extend (e.g., stretch or the like) or collapse (e.g., fold, or the like) away from or towards each other such that the length 450 may be adjusted. In various embodiments, the ridges 452 may include a helical coil or spring extending between the ridges 452 (external, internal, or within the wall of the length 450 of the midportion 403) such that the coil may resist over-collapsing or over-extension of the length 450 and provide support. A scaffolding 460 extends along the length 450 of the midportion 403. The scaffolding 460 includes first and second elongate members 454, 456 that are coupled to support members 458. The support members 458 are coupled to the midportion 403 outside of the length 450. The support members 458 can hold the midportion 403 and/or the first and second portions 401, 402 such that the conduit 400 is maintained in a particular configuration as desired. The scaffolding 460 may be operated to adjust the length 450. To adjust the length 450, the first and second elongate members 454, 456 may be moved with respect to each other (e.g., by one elongate member 454, 456 telescoping within the other or moving along each other such as by a rack and pinion arrangement or the like) such that the support members 458 are moved toward or away from each other, thereby adjusting the length 450. As the length 450 is adjusted, the pathlength [symbol] is also adjusted. The elongate members 454, 456 may be moved relative to each other by unlocking a reversible lock or adjustable gear 462 (e.g., a threaded screw, rack and pinion, worm gear, or the like), moving the elongate members 454, 456 and support members 458 towards or away from each other, and locking or ceasing the reversible lock or adjustable gear 462. The pathlength [symbol] in FIG. 4A is larger than the pathlength [symbol] in FIG. 4B, which may be adjusted between longer and shorter pathlengths 13 by operating the scaffolding 460. For example, a user may operate the scaffolding 460 to move the support members 458 towards each other, shortening the pathlength [symbol] compared to that of FIG. 4A. In various embodiments described herein, the probe 410 and/or the detector 408 may be fixed or extendable with respect to the conduit 400.

Referring to FIGS. 4A and 4C-4H, the sample 404 flowing through the conduit 400 includes a first component 431 and a second component 432 that are separated by a gap space 434, e.g., from being processed by a column upstream of the first portion 401. The components 431, 432 of the sample 404 flow across the pathlength [symbol] such that the detector 408 can measure an absorbance of the light emitted from the probe 410 by the sample 404. FIG. 4C illustrates an instant in time later than that of FIG. 4A where components 431, 432 of the sample 404 are flowing from the first portion 401 towards the midportion 403 of the conduit 400. In FIG. 4C, the first component 431 intersects the pathlength [symbol] such that the detector 408 may measure an absorbance of light from the probe 410. The second component 432 of the sample 404 is still within the first portion 401 and not intersecting the pathlength [symbol] . As illustrated in FIGS. 4D, 4F, and 4H, a first peak 441 is a measured absorbance of light of the first component 431 flowing across the pathlength [symbol] at the instant illustrated in FIG. 4C. In FIG. 4E, the sample 404 continues to flow through the conduit 400 from the instant illustrated in FIG. 4C. Because the gap space 434 in the sample 404 is along the pathlength [symbol] behind the first component 431 from the perspective of the probe 410, there is no valley following the first peak 441 in FIG. 4F (e.g., compared to the valley 244 in FIG. 2C). As the second component 432 intersects the pathlength [symbol] , the detector 408 measures an absorbance of light of both the first component 431 and the second component 432 of the sample 404 along the pathlength [symbol] . The second peak 442 is at least partially an additive combination of absorbance of the first and second components 431, 432, which may be useful to note for post-analysis. In FIG. 4G, the sample 404 continues to flow through the conduit 400 from the instant illustrated in FIG. 4E. The detector 408 is measuring an absorbance of light by the second component 432 coincident with the pathlength [symbol] , which produces a third peak 443 in FIG. 4H. Because the first component 431 is positioned along the mid portion 403 outside of the pathlength [symbol] , the detector 408 is not measuring an absorbance of light of the first component 431. Because the peaks 441, 442, 443 are not separated by valleys (e.g., compared to that of FIG. 2C) and are instead staged with additive absorbance of multiple components, the peaks 441, 442, 443 may not be immediately clear and identifiable and may require post-analysis processing as described herein. In various embodiments, the distal end 410d of the probe 410 may be oriented against or with a direction f of the sample 404 flow (i.e., the sample 404 may instead flow opposing the directions f from the second portion 402, through the midportion 403, and to the first portion 401).

In various embodiments described herein, a pathlength may be parallel with a direction of flow of a sample. This may allow the pathlength to extend longer than a diameter of a conduit containing the sample. This may also allow varying the pathlength without altering a diameter or a volume of a conduit. The same conduit arrangement or dimensions thereof may be used for various concentrated or diluted samples and rather than substituting a conduit, instead a pathlength of the device may be varied. Such arrangements may maximize a pathlength where a sample volume is minimal, e.g., where sample availability is limited in applications such as gene therapy. A pathlength parallel with a direction of flow may reduce a risk of bubble formation, e.g., where there may be insufficient sample volume along the pathlength volume.

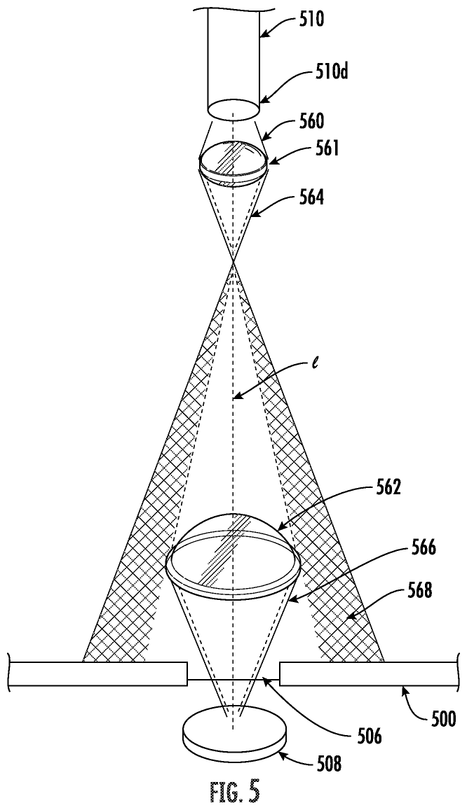

Referring to FIG. 5, embodiments for a device for measuring light absorbance may include one or more lenses 561, 562, in accordance with embodiments of the present disclosure. As a pathlength [symbol] is varied to accommodate process specifications such as a concentration level of a sample within a conduit 500 by moving a distal end 510d of a probe towards or away from a detector 508, a significant portion of light 560 emitting from the probe 510 may diverge or scatter wide of a window 506 and/or the detector 508, resulting in an inaccurate measurement of absorbance. For example, as the pathlength [symbol] is increased, an amount of light 560 not received by the detector 508 may also increase. The arrangement of FIG. 5 reduces lost light 560 with a first converging lens 561 that receives the light 560 emitting from the probe 510. The first lens 561 narrows the initial light 560 into a first narrowed beam 564. However, this first narrowed beam 564 may still diverge or scatter wide of the window 506 and/or the detector 508 if the pathlength [symbol] is long enough. A second converging lens 562 receives at least some of the first narrowed beam 564 and narrows the first narrowed beam 564 into a second narrowed beam 566 towards the window 506 and the detector 508. The detector 508 may receive all of or a significant portion of the light produced by the first and second narrowed beams 564, 566. A portion of one or more of the beams 564, 566 may diverge or scatter wide of the window 506 and/or the detector 508 as lost light 568. Arrangements without significant lost light 568 may reduce or eliminate post-processing analysis or modification to compensate for the lost light 568. Absolute absorbance or reception of the light 560 by a sample and/or a detector 508 may not be necessary. A partial reception of light 560, 564, 566 may be analyzed for absorption in relation to the adjustable pathlength [symbol] without absolute absorbance or reception. In various embodiments, one or more lenses may be useful with devices having volume constraints, e.g., where a diameter of a conduit cannot be further increased without compromising a processed sample (e.g., mixing a separated sample).

In various embodiments described herein, one or more lenses may be included along a pathlength. The one or more lenses may be positioned (e.g., installed, suspended, or the like) at a distance from one or more of a probe, a window, another lens, and/or a detector such that one or more focal lengths may be maintained or adjusted. One or more lenses may be positioned, e.g., in a component such as a stainless steel hypo-tube, a capillary tube, a silica tube, or the like by, e.g., machining, fusing, bonding or the like. One or more lenses of an embodiment may include various surfaces, e.g., flat, concave, convex, a combination thereof, or the like. A single lens may include, e.g., a convex surface opposing a concave surface depending on how light may be desirably manipulated along a pathlength, possibly including compensation or one or more other lenses along the pathlength. One or more lenses may be fixed along a device or system and a conduit may be adjustable (e.g., a length of a midportion) to effectively alter a pathlength along the lens(es).

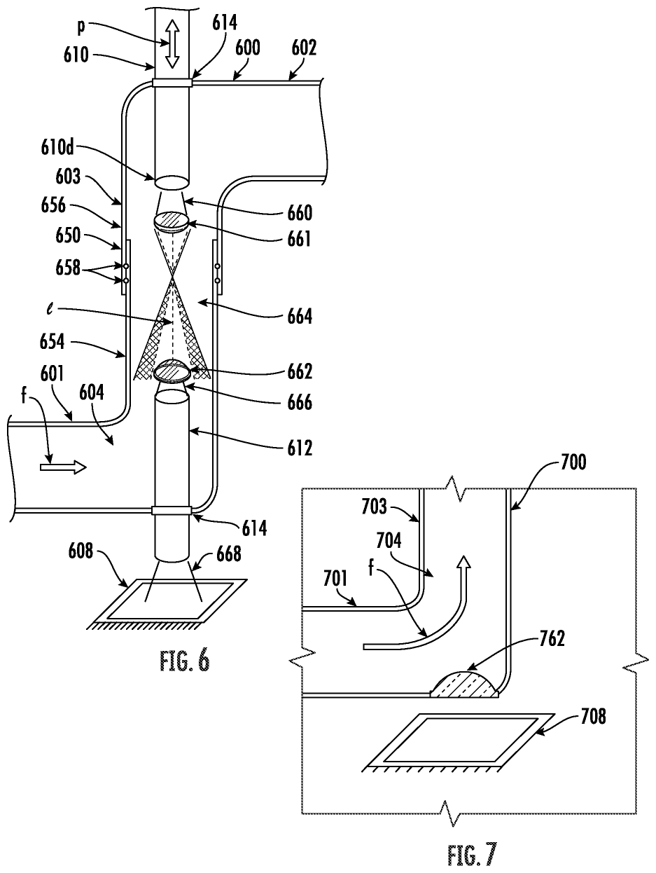

Referring to FIG. 6, an embodiment of a device for measuring light absorbance with a diluted sample 604 is illustrated in accordance with an embodiment of the present disclosure, which includes a fluid conduit 600. The fluid conduit 600 includes a first portion 601, a midportion 603 substantially perpendicular to the first portion 601, and a second portion 602 substantially perpendicular to the midportion 603. The fluid sample 604 is flowing in the direction of the arrow f. A first probe 610 is extending within the midportion 603 substantially parallel with the midportion 603. A light source is operably coupled to the first probe 610 such that light travels along the first probe 610 and is emitted from a distal end 610d of the first probe 610 that is submerged in the sample 604. A detector 608 is aligned with the distal end 610d of the first probe 610 such that a receptive surface of the detector 608 is substantially perpendicular to the first probe 610. Light is emitted from the first probe 610 from the distal end 610d of the first probe 610 to a second probe 612, and thereafter to the detector 608. A length 650 of the midportion 603 includes a first section 654 and a second section 656 of the conduit 600 that are arranged in a telescoping fashion inside each other. A plurality of seals 658 between the first and second sections 654, 656 prevent leakage of the sample 604 from the conduit 600 and provide a frictional hold for the sections 654, 656 of the length 650 to maintain a desired position. In various embodiments, a pathlength [symbol] may be long enough such that one or more lenses 661, 662 and/or the second probe 612 may assist with focusing a light 660 from the first probe 610 along the pathlength [symbol] towards the detector 608. The pathlength [symbol] extends between the first and second lenses 661, 662 and post-processing absorbance data may be needed to compensate for the pathlength [symbol] extending between the lenses 661, 662 (i.e., compared to alternative embodiments without one or more lenses 661, 662). The pathlength [symbol] may be adjusted as desired and as described herein throughout the embodiments, e.g., by moving the first probe 610 and/or lenses 661, 662 in the directions p through a grommet (e.g., a gasket) 614. Additionally, or in the alternative, e.g., the length 650 of the midportion 603 may be adjusted to adjust the pathlength [symbol] . The first lens 661 may receive the emitted light 660 and narrow it to a first narrowed beam 664. The first narrowed beam 664 may be received by the second lens 662. The second lens 662 may assist with focusing the first narrowed beam 664 into a second narrowed beam 666 to be received by the second probe 612. The second probe 612 may contain the second narrowed beam 666 and emit a third beam 668 to the detector 608. In various embodiments described herein, the first and/or second probes 610, 612 may be fixed with respect to the conduit 600. Because the pathlength [symbol] extends between the first and second lenses 661, 662, the absorbance data received by the detector 608 (receiving the third beam 668) may require post-processing background correction to compensate the additional length that the second beam 666 and/or third beam 668 traveled after the pathlength [symbol] . In various embodiments, some the components, e.g., the conduit 600, probes 612, 614, and/or lenses 661, 662 exposed to the sample 604, may be disposable or reused post sterilization while other components, e.g., the detector 608, may be interchangeable or reused without sterilization.

In various embodiments described herein, a pathlength of a device may be extended by emitting light between two probes compared to a device emitting light from one probe to a detector. One or more lenses may be employed to direct a beam of light through the sample along the pathlength to improve absorption measurements. For example, a lens may divert a beam of light away from a wall of a conduit and/or convert towards another lens, a probe, and/or a detector, i.e., for a detector to capture additional light and minimize lost light. For example, a probe may be an optical fiber having a numerical aperture of about 0.22 that corresponds to an acceptance angle of light emission of about 25°, such that light enters the probe with a cone of acceptance defined by this angle that may be captured and transmitted through the probe. In various embodiments, multi-mode fibers may be used that substantially preserve input angles and influence a beam output. Light outside of this angle may pass through the side of the probe. Probes, e.g., optical fiber, may substantially preserve light conditions so it may exit the probe with substantially the same angle of coned light, e.g., for transmission to a detector. As a probe increases in length preservation of light conditions may diminish, e.g., light may extend beyond functional boundaries of a detector, a lens, a flow channel of a conduit, or another probe. Light lost in such ways may manifest as an increase in photometric absorbance response in measured data. In various embodiments where light is expected to be lost baseline correction may be performed pre, during, and/or post (e.g., background) operation such that the data analysis accounts for the light expected at each pathlength(s) (e.g., similar to taring a scale). In various embodiments, a lens configured to receive light before a probe and/or a detector may be configured to capture as much light as possible and focus it into the receiving probe and/or detector. In various embodiments, a lens may have a diameter larger, substantially similar, or smaller than a diameter of a probe and/or a detector that the lens is transferring light towards.

Referring to FIG. 7 a device for measuring light absorbance is illustrated in accordance with an embodiment of the present disclosure including a sample 704 flowing through a conduit 700 in the direction of the arrow f. The conduit 700 includes a first portion 701 and a midportion 703 substantially perpendicular to the first portion 701. The conduit 700 includes a lens 762 along a wall of the conduit 700. The lens 762 is arranged substantially perpendicular to the midportion 703 such that a light emitted along the midportion 703 towards the lens 762 may be transferred through the lens 762 to a detector 708 adjacent the lens 762. Such an arrangement may better converge light across the conduit 700 to the detector 708 compared to a window that is not a lens. In various embodiments described herein, a probe and/or a window may be replaced with the lens 762 arrangement of FIG. 7.

### CONCLUSION

Devices, systems, and methods described herein relate to measuring light absorbance and determining spectrophotometric characteristics of a sample by employing an approach that permits the use of a variable pathlength for multiple determinations of parameters of interest. For example, measured absorbance at various pathlengths within a sample can be used to calculate a concentration and/or components of a sample. The devices and methods of the present invention are particularly useful for determining a concentration and/or components of diluted samples. This attribute may be possible due to the large pathlengths at which the devices of the present disclosure can achieve. Embodiments herein can expand the dynamic range of a standard spectrophotometer by permitting a wide range of pathlengths for measuring the absorbance values of a solution. For example, devices of the present disclosure can be used to measure samples with pathlengths of about 0.1 μm and longer such as about 0.5 μm to about 15 mm, between about 1 μm to about 25 mm, between about 1 μm to about 50 mm, and the like and may include various resolution, e.g., about 0.05 μm, 25 μm, and the like. While certain embodiments of the present disclosure are for determining the absorbance or concentration of a sample, various embodiments herein may be alternatively measure scattering, luminescence, photoluminescence, photoluminescence polarization, time-resolved photoluminescence, photoluminescence life-times, chemiluminescence, and the like. Embodiments herein can be used to determine optical values of one or more samples at a given time. Single sample formats such as cuvettes or any sample holder are contemplated, as well as multiple sample formats such as microtiter plates and multiple cuvette or multiple sample arrangements.

As described herein, a probe is a light delivery device that delivers light to a sample. A probe may be a single light delivery device such as a fiber optic cable that interfaces with one or more electromagnetic sources to permit passage of light through the sample. Alternatively, a probe tip may be housed in a probe tip assembly that may comprise of a light delivery device, housing, end terminations, and other optical components and coatings. A light delivery device can be fused silica, glass, plastic, or any transmissible material appropriate for the wavelength range of the electromagnetic source and detector. The light delivery device may be comprised of a single fiber or of multiple fibers and these fibers can be of different diameters depending on the utilization of the instrument. A probe may be of almost any diameter, e.g., about 5 mm to about 10 mm, about 1 mm to about 3.1 mm, about 300 μm, about 200 μm, and the like.

In various embodiments, an electromagnetic radiation source may provide light in a predetermined fashion across a wide spectral range or in a narrow band. A light source may include arc lamps, incandescent lamps, fluorescent lamps, electroluminescent devices, laser, laser diodes, and light emitting diodes, as well as other sources. Alternatively, a light source could be a light emitting diode that can be mounted directly onto a probe tip.

In various embodiments, a detector may comprise any mechanism capable of converting energy from detected light into signals that may be processed. Suitable detectors include photomultiplier tubes, photodiodes, avalanche photodiodes, charge-coupled devices (CCD), and intensified CCDs, among others. Depending on the detector, light source, and assay mode such detectors may be used in a variety of detection modes including but not limited to discrete, analog, point, or imaging modes. Detectors can used to measure absorbance, photoluminescence and/or scattering. Embodiments herein may use one or more detectors integrated or separate from a device and can be located remotely by operably linking the detector(s) to a probe that can carry electromagnetic radiation through the sample to the detector.

In various embodiments, a probe may comprise fused silica, glass, plastic, any transmissible material appropriate for the wavelength range of the electromagnetic source and detector, or a combination thereof. A probe may comprise a single fiber or multiple fibers and these fibers can be of different diameters depending on the utilization of the instrument. The fibers can be of almost any diameter, e.g., about 0.005 mm to about 20.0 mm or the like.

In various embodiments, multiple absorbance measurements may be taken at multiple pathlengths without accurately knowing what the pathlength distance is. An absorbance reading may be analyzed to accurately determine a concentration and/or components of a sample. For example, multiple absorbance measurements made at varying pathlengths may assist with calculating concentrations, aggregation, full or empty capsid ratios, purity, or components. For example, a slope of a regression line can be used to calculate a concentration and/or components of a sample. Each pathlength need not be accurately known because post-processing may be used to calculate a regression line.

In various embodiments, a user may optimize collection of data by selecting a pre-determined parameter such as absorbance. The user can define, e.g., an absorbance of 1.0 and have the instrument measure other parameters (such as wavelength or pathlength) at which the absorbance of the sample is 1.0.

The present disclosure is not limited to the particular embodiments described. The terminology used herein is for the purpose of describing particular embodiments only and is not intended to be limiting. Unless otherwise defined, all technical terms used herein have the same meaning as commonly understood by one of ordinary skill in the art to which the disclosure belongs.

As used herein, the singular forms “a,” “an,” and “the” are intended to include the plural forms as well, unless the context clearly indicates otherwise. The terms “comprises” and/or “comprising,” or “includes” and/or “including” when used herein, specify the presence of stated features, regions, steps elements and/or components, but do not preclude the presence or addition of one or more other features, regions, integers, steps, operations, elements, components and/or groups thereof. As used herein, the conjunction “and” includes each of the structures, components, features, or the like, which are so conjoined, unless the context clearly indicates otherwise, and the conjunction “or” includes one or the others of the structures, components, features, or the like, which are so conjoined, singly and in any combination and number, unless the context clearly indicates otherwise. The term “or” is generally employed in its sense including “and/or” unless the content clearly dictates otherwise.

All numeric values are herein assumed to be modified by the term “about,” whether or not explicitly indicated. The term “about”, in the context of numeric values, generally refers to a range of numbers that one of skill in the art would consider equivalent to the recited value (i.e., having the same function or result). In many instances, the term “about” may include numbers that are rounded to the nearest significant figure. Other uses of the term “about” (i.e., in a context other than numeric values) may be assumed to have their ordinary and customary definition(s), as understood from and consistent with the context of the specification, unless otherwise specified. The recitation of numerical ranges by endpoints includes all numbers within that range, including the endpoints (e.g., 1 to 5 includes 1, 1.5, 2, 2.75, 3, 3.80, 4, and 5).

It is noted that references in the specification to “an embodiment”, “some embodiments”, “other embodiments”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to affect such feature, structure, or characteristic in connection with other embodiments, whether or not explicitly described, unless clearly stated to the contrary. That is, the various individual elements described below, even if not explicitly shown in a particular combination, are nevertheless contemplated as being combinable or arrangeable with each other to form other additional embodiments or to complement and/or enrich the described embodiment(s), as would be understood by one of ordinary skill in the art.

What is claimed is:

1. A device for measuring light absorbance of a sample, comprising:
a fluid conduit comprising a first portion, a midportion substantially perpendicular to the first portion, and a second portion substantially perpendicular to the midportion;
a first probe within the midportion and substantially parallel with the midportion, the first probe comprising a distal end;
a light source operably coupled to the first probe; and
a detector aligned with the distal end of the first probe and substantially perpendicular to the first probe and disposed at a pathlength from the distal end of the first probe.

2. The device of claim 1, wherein the midportion comprises a length that is adjustable such that the pathlength is adjustable.

3. The device of claim 2, wherein the length of the midportion that is adjustable comprises a conduit wall that is axially foldable.

4. The device of claim 3, further comprising a helical coil within the wall along the length of the midportion.

5. The device of claim 2, wherein the length of the midportion that is adjustable comprises a plurality of telescoping walls.

6. The device of claim 2, further comprising a scaffolding extending between the first portion and the second portion along the mid portion.

7. The device of claim 6, wherein the scaffolding comprises a reversibly locking telescoping portion.

8. The device of claim 6, wherein the scaffolding comprises a screw and threads.

9. The device of claim 1, wherein the first probe is fixed to the fluid conduit.

10. The device of claim 1, further comprising a lens coincident with the pathlength.

11. The device of claim 1, further comprising a second probe between the first probe and the detector.

12. A device for measuring light absorbance of a sample, comprising:
a fluid conduit comprising a first portion, a midportion substantially perpendicular to the first portion, and a second portion substantially perpendicular to the midportion;
a first probe extendable within the midportion;
a light source couple to the first probe; and
a detector arranged substantially perpendicular to the light source and disposed at a pathlength from the distal end of the first probe.

13. The device of claim 12, further comprising a lens coincident with the pathlength.

14. The device of claim 12, further comprising a second probe between the first probe and the detector.

15. A device for measuring light absorbance of a sample, comprising:
a fluid conduit comprising a first portion, a midportion substantially perpendicular to the first portion, and a second portion substantially perpendicular to the midportion;
a restrictor valve coupled to the second portion;
a probe extendable within the midportion;
a light source couple to the first probe; and
a detector arranged substantially perpendicular to the light source and disposed at a pathlength from the distal end of the first probe.

16. The device of claim 15, wherein the first portion and the second portion are substantially aligned along a parallel axis, and the midportion comprises a reservoir extending away from the parallel axis.

17. The device of claim 15, wherein the restrictor valve is configured to reduce a flowrate of the sample from the mid portion through the second portion such that a head is established along the probe.

18. The device of claim 17, wherein the pathlength and the head are related to each other.

19. The device of claim 15, wherein the first portion is downstream of a chromatography column.

20. The device of claim 15, wherein the probe is substantially parallel with the midportion.
